(19) United States
(12) Patent Application Publication
(10) Pub. No.: US 2025/0205737 A1
(43) Pub. Date: Jun. 26, 2025

(54) ULTRASONIC TRANSDUCER ARRAY AND ULTRASONIC PROBE

(71) Applicant: Qisda Corporation, Taoyuan City (TW)

(72) Inventors: Hsi-Hsun Wang, Taoyuan City (TW); Fu-Sheng Jiang, Taoyuan City (TW); Pei-Lun Song, Taoyuan City (TW)

(73) Assignee: Qisda Corporation, Taoyuan City (TW)

(21) Appl. No.: 18/974,788

(22) Filed: Dec. 10, 2024

(30) Foreign Application Priority Data
Dec. 21, 2023 (TW) 112149906

(51) Int. Cl. B06B 1/06

(52) U.S. Cl. CPC B06B 1/0622

(57) ABSTRACT

Disclosed is an ultrasonic transducer array configured to generate ultrasonic waves. The ultrasonic transducer array includes multiple transducers arranged along a first direction. Each of the transducers has multiple grooves arranged along a second direction perpendicular to the first direction. The grooves extends along the first direction. A density of the grooves along the second direction decreases from both ends of the transducer toward a center of the transducer.

### CROSS-REFERENCE TO RELATED APPLICATION

This application claims the priority benefit of Taiwan application serial no. 112149906, filed on Dec. 21, 2023. The entirety of the above-mentioned patent application is hereby incorporated by reference herein and made a part of this specification.

### BACKGROUND

### Technical Field

The disclosure relates to an ultrasonic transducer array and an ultrasonic probe.

### Description of Related Art

The method of using an ultrasonic transducer to generate ultrasonic is widely used in many fields, such as generating high-quality ultrasonic images in the medical field. When an ultrasonic transducer is used to generate ultrasonic, the resolution of the ultrasonic image is affected due to an effect of side lobes. Generally, by changing the thickness of the piezoelectric material configured to generate ultrasonic, the effect of the side lobes may be effectively suppressed to eliminate the energy of the side lobes, improve the signal-to-noise ratio, and thereby improve the resolution of the ultrasonic image. In addition, by suppressing the effect of the side lobes of ultrasonic, an aperture of the ultrasonic transducer may be reduced, thereby reducing a size of an ultrasonic probe system. On the other hand, when ultrasonic is incident on an object to be measured, such as human tissue, the ultrasonic may be attenuated and phase changed due to absorption by the object to be measured. By suppressing the effect of the side lobes of ultrasonic, the interference caused by the side lobes of ultrasonic may be reduced. Therefore, how to make the ultrasonic transducer effectively suppress the effect of the side lobes is an important issue in this field.

### SUMMARY

The disclosure provides an ultrasonic transducer array and an ultrasonic probe to suppress the power of side lobes of the output ultrasonic.

An ultrasonic transducer array of the disclosure is configured to generate ultrasonic. The ultrasonic transducer array includes multiple transducers, where the transducers are arranged along a first direction, each of the transducers has multiple grooves arranged along a second direction perpendicular to the first direction, and the grooves extend along the first direction, where a density of the grooves along the second direction decreases from both ends of the transducer toward a center of the transducer.

According to some embodiments, the density of the grooves along the second direction corresponds to an energy distribution function, and the energy distribution function makes a power difference between a power of a main lobe and a power of side lobes of the ultrasonic greater than 20 dB.

According to some embodiments, the energy distribution function is a Kaiser Window.

According to some embodiments, the transducer is divided into multiple equal portions along the second direction, and the number of the grooves in each of the equal portions corresponds to the distribution of an energy distribution function, and the energy distribution function makes the power difference between the main lobe and the side lobes of the ultrasonic greater than 20 dB.

According to some embodiments, a number of the equal portions is N, and a number nᵢ of grooves in an i-th equal portion is in the following relation and is rounded down to an integer of integer digits:

$$( 1 - \frac{{E}_{i}}{{E}_{max}} ) \frac{L}{N} \frac{1}{d} ,$$

wherein Eᵢ is an energy of the energy distribution function at the i-th equal portion, Eₘₐₓ is a maximum energy of the energy distribution function, L is a width of the transducer along the second direction, and d is a width of the groove.

According to some embodiments, the transducer along the second direction is divided into multiple equal portions, and a central equal portion of the equal portions does not have a groove.

According to some embodiments, depths of the grooves decrease from both ends of the transducer toward the center of the transducer.

According to some embodiments, a depth of the groove is greater than or equal to half of a height of the transducer, and a width of the transducer along the second direction is half of a wavelength of the ultrasonic.

According to some embodiments, each of the transducers is a rectangle, wherein a short side of the rectangle extends along the first direction, and a long side of the rectangle extends along the second direction.

According to some embodiments, at least one of a number and depths of the grooves is symmetrically distributed relative to the center of the transducer.

An ultrasonic probe of the disclosure includes a handheld housing having a first end and a second end, an acoustic lens disposed at the first end or the second end of the handheld housing, and an ultrasonic transducer array disposed in the handheld housing and close to one side of the acoustic lens.

Based on the above, by cutting the transducer array, the ultrasonic waveform output by the transducer array is changed, and the power of the side lobes of the output ultrasonic is suppressed, so as to improve the focusing function of the ultrasonic generated by the transducer array, thereby improving the resolution of the detected ultrasonic image.

### BRIEF DESCRIPTION OF THE DRAWINGS

FIG. 1 is a schematic view of an ultrasonic probe according to an embodiment of the disclosure.

FIG. 2 is a side view of an ultrasonic transducer array according to an embodiment of the disclosure.

FIG. 3 is a top view of an ultrasonic transducer array according to an embodiment of the disclosure.

FIG. 4 is a side view of a transducer according to an embodiment of the disclosure.

FIG. 5 is a partial side view of a transducer according to an embodiment of the disclosure.

FIG. 6A is an energy distribution function of a transducer according to an embodiment of the disclosure.

FIG. 6B is a distribution diagram of a number of grooves of a transducer according to an embodiment of the disclosure.

FIG. 7A, FIG. 7B, and FIG. 7C are waveform distributions of ultrasonic emitted by a transducer under different window functions according to an embodiment of the disclosure.

FIG. 8 is a radiation pattern of ultrasonic emitted by a transducer according to an embodiment of the disclosure.

### DESCRIPTION OF THE EMBODIMENTS

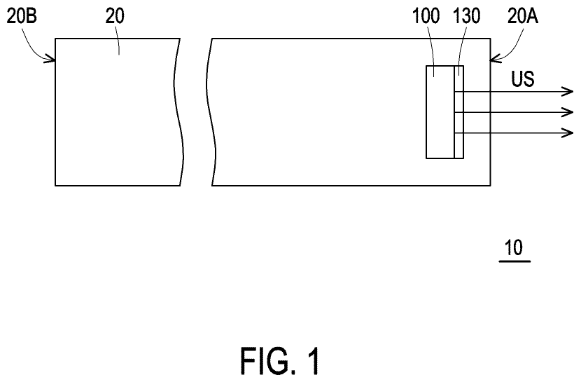

FIG. 1 is a schematic view of an ultrasonic probe according to an embodiment of the disclosure. Referring to FIG. 1, an ultrasonic probe 10 includes a handheld housing 20, an ultrasonic transducer array 100, and an acoustic lens 130.

The handheld housing 20 is a long housing with a first end 20A and a second end 20B, which are respectively located on opposite sides of the housing. In some embodiments, the housing is made of plastic or other similar materials, but the disclosure is not limited thereto. A size of the housing is suitable for a user to hold with one hand, but the disclosure is not limited thereto.

The acoustic lens 130 is disposed at the first end 20A or the second end 20B of the handheld housing 20 and may be configured to focus an ultrasonic US emitted by the ultrasonic transducer array 100 and reduce the reflection of the ultrasonic US incident on an object to be measured. In some embodiments, the acoustic lens 130 is located at one of the first end 20A or the second end 20B of the handheld housing 20 while the user holds the other one of the first end 20A or the second end 20B of the handheld housing 20. For example, in this embodiment, the acoustic lens 130 is located at the first end 20A of the handheld housing 20, and the user holds the second end 20B of the handheld housing 20. In some embodiments, the acoustic lens 130 is made of rubber or other materials with similar properties, which is not limited by the disclosure. In some embodiments, the acoustic lens 130 is a convex lens.

The ultrasonic transducer array 100 is disposed in the handheld housing 20 and is close to one side of the acoustic lens 130. The ultrasonic transducer array 100 emits the ultrasonic US. After being incident on the acoustic lens 130, the ultrasonic US is focused by the acoustic lens 130 and illuminates a target object. A specific structure of the ultrasonic transducer array 100 is described below.

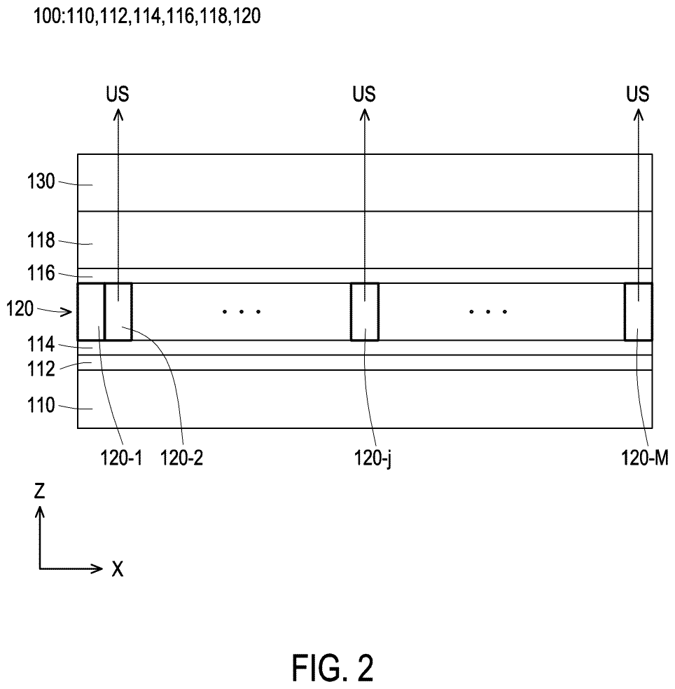

FIG. 2 is a side view of an ultrasonic transducer array according to an embodiment of the disclosure. As shown in FIG. 2, the ultrasonic transducer array 100 includes a substrate 110, a flexible circuit board 112, a first electrode 114, a transducer layer 120, a second electrode 116, and an acoustic matching layer 118.

In addition to carrying the ultrasonic transducer array 100, the substrate 110 may be configured to absorb the ultrasonic radiated by the transducer layer 120 in a direction of the substrate 110 to prevent the ultrasonic interference caused by the reflection of the substrate 110.

The flexible circuit board 112 is disposed above the substrate 110. The first electrode 114 is disposed above the flexible circuit board 112 and is electrically connected to the flexible circuit board 112 for connecting the transducer layer 120. The flexible circuit board 112, the first electrode 114, and the second electrode 116 located above the transducer layer 120 apply voltage to the transducer layer 120, so that the transducer layer 120 generates the ultrasonic US. The disclosure does not limit the materials of the flexible circuit board, first electrode, and second electrode.

The acoustic matching layer 118 is located above the second electrode 116. Since the acoustic impedance difference between the acoustic lens 130 and the transducer layer 120 is too large, and when the ultrasonic US generated by the transducer layer 120 is directly incident on the acoustic lens 130, the large reflection may occur on an incident surface of the acoustic lens 130, which causes the ultrasonic energy loss. Therefore, the acoustic matching layer 118 is required between the transducer layer 120 and the acoustic lens 130 to achieve matching between the transducer layer 120 and the acoustic lens 130 to reduce the reflection of the ultrasonic US when the ultrasonic US is incident on the acoustic lens 130. In some embodiments, the material and thickness of the acoustic matching layer 118 are determined according to actual requirements. Generally, a thickness of the acoustic matching layer 118 is about one quarter of a wavelength of the ultrasonic US, but the disclosure is not limited thereto.

The acoustic lens 130 is located above the acoustic matching layer 118 for gathering the ultrasonic US emitted by the transducer layer 120 and reducing the reflection of the ultrasonic US incident on the object to be measured.

A structure of the transducer layer 120 is described below.

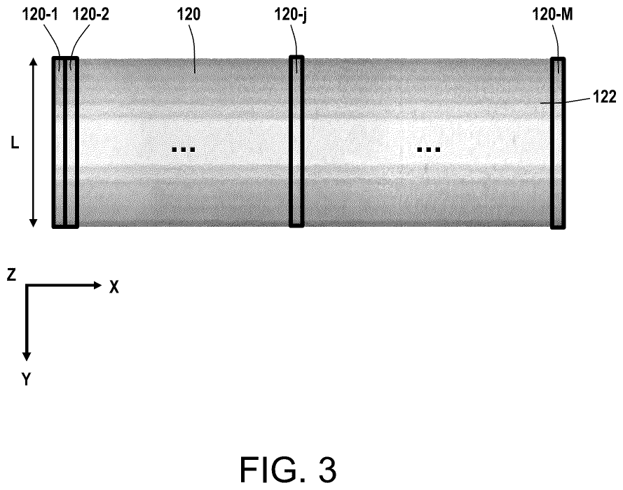

FIG. 3 is a top view of an ultrasonic transducer array according to an embodiment of the disclosure. Please refer to FIG. 2 and FIG. 3 at the same time.

The transducer layer 120 is located between the first electrode 114 and the second electrode 116 and is electrically connected to the flexible circuit board 112, the first electrode 114, and the second electrode 116.

The transducer layer 120 includes multiple transducers 120-1, 120-2 . . . 120-j . . . 120-M. The transducers 120-1, 120-2 . . . 120-j . . . 120-M are arranged along a first direction (an X direction). In this embodiment, the number of transducers in the transducer layer 120 is M, and M is a positive integer greater than or equal to 1. In some embodiments, M may be 50 to 200 and may also have other values according to actual needs, but the disclosure is not limited thereto.

In some embodiments, a material of the transducers 120-1, 120-2 . . . 120-j . . . 120-M is a piezoelectric material. Therefore, when the same voltage is applied to the transducers 120-1, 120-2 . . . 120-j . . . 120-M by the flexible circuit board 112, the first electrode 114, and the second electrode 116, the piezoelectric material of the transducers 120-1, 120-2 . . . 120-j . . . 120-M may vibrate due to the applied voltage, thereby generating the ultrasonic US.

In some embodiments, each transducer 120-1, 120-2 . . . 120-j . . . 120-M has the same shape and structure. For example, each transducer 120-1, 120-2 . . . 120-j . . . 120-M has the same length and width. In some embodiments, each of the transducers 120-1, 120-2 . . . 120-j . . . 120-M is a rectangle, where a short side of the rectangle extends along the first direction (the X direction), and a long side of the rectangle extends along a second direction (a Y direction).

Since each transducer 120-1, 120-2 . . . 120-j . . . 120-M has the same shape and structure, and when the same voltage is applied to the transducer 120-1, 120-2 . . . 120-j . . . 120-M by the flexible circuit board 112, the first electrode 114, and the second electrode 116, the transducer 120-1, 120-2 . . . 120-j . . . 120-M may generate and superimpose the same ultrasonic US to generate an ultrasonic beam with sufficient energy.

Please refer to FIG. 3 again. As shown in FIG. 3, each of the transducers 120-1, 120-2 . . . 120-j . . . 120-M has multiple grooves 122 arranged along the first direction (the X direction) perpendicular to the second direction (the Y direction). The grooves 122 extend along the first direction (the X direction). The density of the grooves 122 along the second direction (the Y direction) decreases from both ends of the transducers 120-1, 120-2 . . . 120-j . . . 120-M toward a center of the transducers 120-1, 120-2 . . . 120-j . . . 120-M. The relation between the transducers 120-1, 120-2 . . . 120-j . . . 120-M and the grooves 122 is described below.

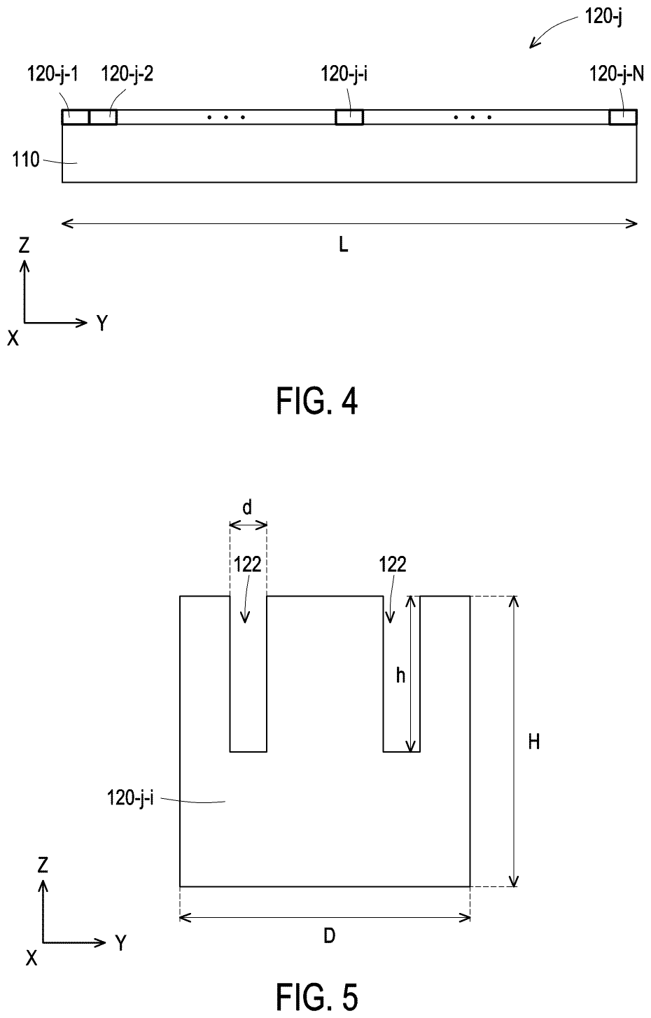

FIG. 4 is a side view of a transducer according to an embodiment of the disclosure. Please refer to FIG. 4. Since each transducer 120-1, 120-2 . . . 120-j . . . 120-M in FIG. 2 and FIG. 3 has the same properties, without loss of generality, the transducer 120-j is taken as an example to illustrate a structure of the transducer 120-j, where j may be any positive integer between 1 and M.

FIG. 4 is a side view of the transducer 120-j in FIG. 3. As shown in FIG. 4, the transducer 120-j is disposed above the substrate 110. To simplify the view, the flexible circuit board 112 and the first electrode 114 are not shown in FIG. 4.

A width of the transducer 120-j along the second direction (the Y direction) is L, which is the same as a width of the transducer layer 120 in the second direction. In some embodiments, the width L along the second direction (the Y direction) of the transducer 120-j is half of the wavelength of the emitted ultrasonic.

The transducer 120-j along the second direction (the Y direction) is divided into multiple equal portions. As shown in FIG. 4, the transducer 120-j along the second direction (the Y direction) is divided into N equal portions in order of a first equal portion 120-j−1, a second equal portion 120-j−2 . . . an i-th equal portion 120-j−i . . . an Nth equal portion 120-j−N. In some embodiments, N is a positive integer greater than or equal to 1. In some embodiments, N may range from 10 to 100, but N may also be selected according to actual needs, and the disclosure is not limited thereto.

When the transducer 120-j along the second direction is divided into the equal portions, each equal portion 120-j−i (“i” is an integer between 1 and N) may be regarded as an individual ultrasonic emission source to emit a specific frequency ultrasonic. In this embodiment, the frequency of ultrasonic is 7.5 MHz, but in other embodiments, the frequency of ultrasonic may also be other suitable frequencies according to actual needs, and the disclosure is not limited thereto. When the N equal portions 120-j−1 to 120-j−N of the transducer 120-j emit ultrasonic at the same time, the ultrasonic beams emitted by each equal portion are superimposed on each other, so that the superposed ultrasonic beam has a specific waveform.

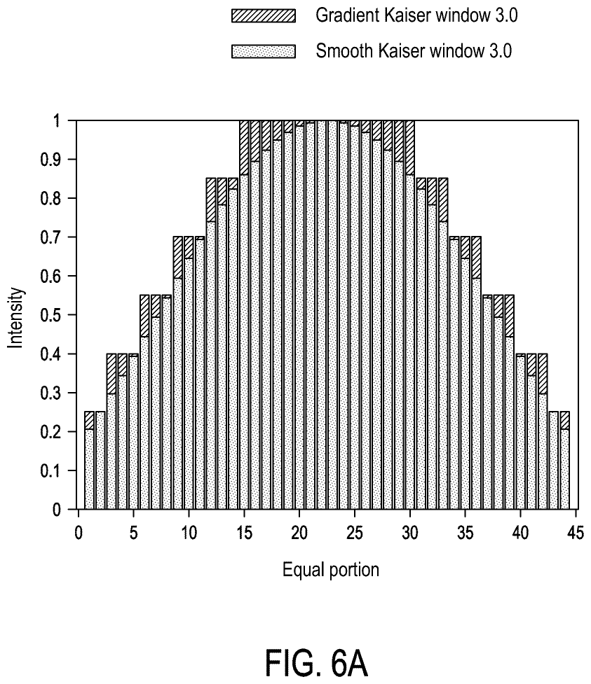

FIG. 5 is a partial side view of a transducer according to an embodiment of the disclosure. Specifically, FIG. 5 shows the i-th equal portion 120-j−i of the transducer 120-j in FIG. 4. As shown in FIG. 5, a height of the i-th equal portion 120-j−i is H, and a width of the i-th equal portion 120-j−i is D.

In this embodiment, the i-th equal portion 120-j−i has two grooves 122. Each groove 122 is the same size and shape. A width of the groove 122 is d, and a depth of the groove 122 is h. In some embodiments, the depth of the groove 122 decreases from both ends of the transducer 120-j toward the center of the transducer 120-j. In some embodiments, the depth h of the groove 122 is greater than or equal to half of the height H of the transducer 120-j.

The density of the groove 122 along the second direction in each portion decreases from both ends of the transducer 120-j toward the center of the transducer 120-j. That is, the number of grooves 122 is related to a position of the i-th equal portion. The number of grooves 122 is smaller in the central part close to the transducer 120-j, and the number of grooves 122 is larger in the parts of both ends close to the transducer 120-j.

In addition, in some embodiments, at least one of the number and depth of grooves 122 is symmetrically distributed relative to the center of the transducer 120-j.

When the transducer 120-j emits the ultrasonic along a third direction (a Z direction), an angular distribution of the emitted ultrasonic on the plane between the second direction (the Y direction) and the third direction (the Z direction) has a main lobe roughly along the Z direction and side lobes next to the main lobe. In order to make the ultrasonic have good imaging quality, the power difference between the power of the main lobe and the power of the side lobes of the ultrasonic may be greater than 20 dB to avoid the interference in the main lobe from the side lobes.

In order to make the ultrasonic emitted by the transducer 120-j meet the above conditions, the disclosure calculates the energy distribution function of the transducer 120-j in a simulation manner, so that the ultrasonic emitted by each equal portion 120-j−i of the transducer 120-j (“i” is an integer between 1 and N) may have a characteristic that the power difference between the power of the main lobe and the power of the side lobes of the ultrasonic is greater than 20 dB after each equal portion 120-j−i of the transducer 120-j adjusts the energy distribution.

Specifically, the disclosure uses a simulation manner to allow each section 120-j−i of the transducer 120-j to emit the ultrasonic of the same energy at first and calculate the energy distribution function emitted by the transducer 120-j to find the energy distribution function of the transducer 120-j that meets the power difference between the power of the main lobe and the power of the side lobes greater than 20 dB after the ultrasonic passes a window function.

Generally, conventional window functions include a rectangular, a Hamming window, a Hanning window, a Kaiser window, a Taylor window, etc. In the disclosure, various window functions and corresponding parameters are tested, and the energy distribution function corresponding to a Kaiser window meets a requirement that the power difference between the power of the main lobe and the power of the side lobes of the ultrasonic is greater than 20 dB. Specifically, in some embodiments, when the window function is a Kaiser window and a parameter beta is 3.0, 4.0, or 5.0 (referred to as a Kaiser window 3.0, a Kaiser window 4.0, or a Kaiser window 5.0), the window function may be applied to different ultrasonic probes 10, and the energy distribution function obtained at the same time may be more adaptable for the measurement under certain situations. For example, shorter short-axis probes (such as 4.4 mm) are adaptable for an application of the Kaiser Window 3.0, while longer short-axis probes (such as 5 mm or above) are more adaptable for applications of the Kaiser Window 4.0 or the Kaiser Window 5.0.

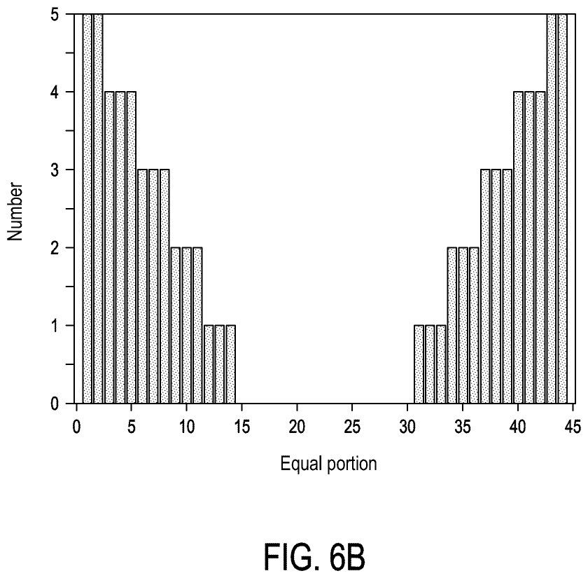

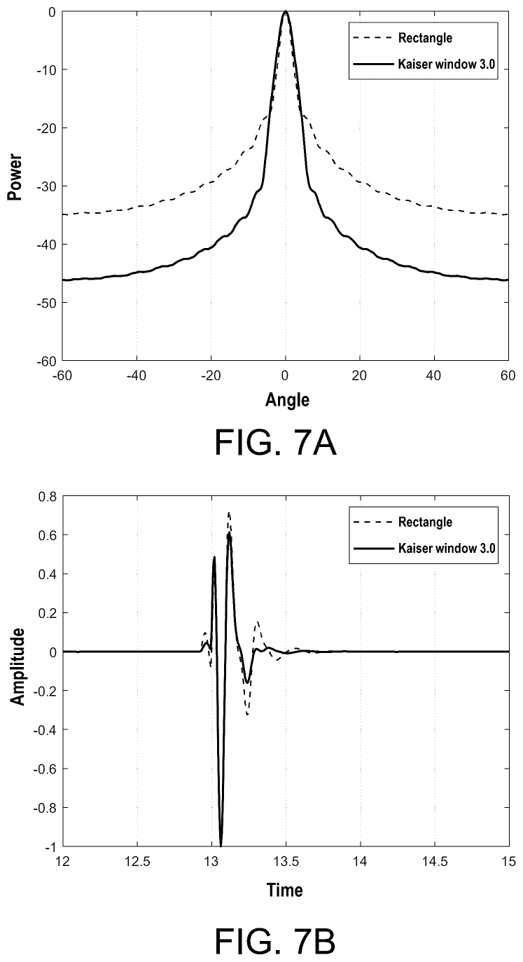

FIG. 6A is an energy distribution function of a transducer according to an embodiment of the disclosure. FIG. 6B is a distribution diagram of a number of grooves of a transducer according to an embodiment of the disclosure. Referring to FIG. 6A, FIG. 6A shows that the transducer (such as the transducer 120-j in FIG. 4) along the second direction is divided into 44 equal portions, and the energy distribution function (shown as a smooth 3.0 curve in the figure) is the Kaiser window 3.0.

In FIG. 6A, the number represented by each point in the energy distribution function represents the energy emitted by that part of the transducer (such as the i-th equal portion 120-j−i) is several times the maximum energy that the part is able to emit. For example, when i=10, the value is about 0.65, which means that the energy emitted by the 10th equal portion is 0.65 times the maximum energy of the equal portion.

Since the energy emitted by the i-th equal portion of the transducer is proportional to the surface area of the i-th equal portion, and in order to reduce the energy emitted by the i-th equal portion of the transducer, the surface area of the i-th equal portion may be decreased by reducing the energy emitted by the i-th equal portion. In some embodiments, the method of decreasing the i-th equal portion in the transducer may be, for example, cutting the grooves 122 on the surface of the transducer 120-j by using a blade. Therefore, the density of the grooves 122 along the second direction (the Y direction) corresponds to the energy distribution function, and the energy distribution function makes the power difference between the power of the main lobe and the power of the side lobes of the ultrasonic greater than 20 dB.

The method of determining the number of grooves 122 in the i-th equal portion of the transducer 120-j is as follows. The number of equal portions of the transducer 120-j is N, and the number of grooves 122 of the i-th equal portion is nᵢ, then nᵢ is rounded down to an integer in the following relation:

$${n}_{i} = ( 1 - \frac{{E}_{i}}{{E}_{max}} ) \frac{L}{N} \frac{1}{d} \qquad ( 1 )$$

Eᵢ is the energy of the energy distribution function at the i-th equal portion, Eₘₐₓ is the maximum energy of the energy distribution function, L is the width of the transducer 120-j along the second direction, and d is the width of the groove 122.

The following embodiment is taken as an example. In other embodiments, each parameter may be adjusted according to actual needs, which is not limited to this embodiment. In this embodiment, if L is 4400 m and is divided into 44 equal portions, then the width of each equal portion is L/N=D=100 m, where D is the width of the i-th equal portion 120-j−i in FIG. 5.

If the width of the cutting blade is d=15 m, then the following situation occurs according to Equation (1).

If Eᵢ/Eₘₐₓ is greater than 0.85, then this equal portion is not cut according to Equation (1). The emitted energy is 1.00 times the maximum energy.

If Eᵢ/Eₘₐₓ is equal to or less than 0.85 and greater than 0.7, then this equal portion is cut once to generate one groove 122 according to Equation (1). The emitted energy is 0.85 times the maximum energy.

If Eᵢ/Eₘₐₓ is equal to or less than 0.7 and greater than 0.55, then this equal portion is cut twice to generate two grooves 122 according to Equation (1). The emitted energy is 0.70 times the maximum energy.

If Eᵢ/Eₘₐₓ is equal to or less than 0.55 and greater than 0.40, then this equal portion is cut three times to generate three grooves 122 according to Equation (1). The emitted energy is 0.55 times the maximum energy.

If Eᵢ/Eₘₐₓ is equal to or less than 0.40 and greater than 0.25, then this equal portion is cut four times to generate four grooves 122 according to Equation (1). The emitted energy is 0.4 times the maximum energy.

If Eᵢ/Eₘₐₓ is equal to or less than 0.25 and greater than 0.10, then this equal portion is cut five times to generate five grooves 122 according to Equation (1). The emitted energy is 0.25 times the maximum energy.

According to the above calculation, the distribution of the energy emitted by each portion 120-j−i of the transducer 120-j is shown as the gradient Kaiser window 3.0 curve in FIG. 6A. The number of grooves in each portion 120-j−i of the transducer 120-j is shown in FIG. 6B.

As shown in FIG. 6A, the energy density function is the largest in the central area and is the smallest when being close to both ends. Therefore, the number of corresponding grooves is the smallest in the central area, and then gradually increases toward both ends. As shown in FIG. 6B, in the Nth (N=44) portion 120-j−I of the transducers 120-j (“i” is an integer between 1 and N), the center equal portion (for example, “i” is an integer between 15 and 30) does not have a groove 122. The density (that is, the number) of the grooves 122 decreases from both ends (for example, “i” is 1 or 44) of the transducer 120-j toward the center of the transducer 120-j.

The following is an example of comparing the energy distribution functions calculated by using the Kaiser window 3.0 and the conventional rectangular window under different window functions.

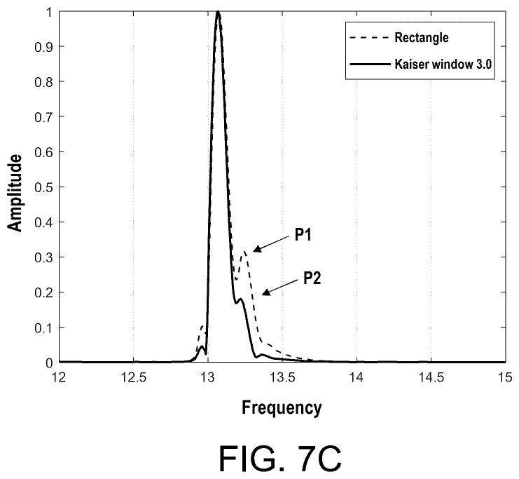

FIG. 7A, FIG. 7B, and FIG. 7C are waveform distributions of ultrasonic emitted by a transducer under different window functions according to an embodiment of the disclosure.

FIG. 7A shows a wave diagram emitted by a single transducer under different window functions. As shown in FIG. 7A, when the window function is a Kaiser window 3.0, there is a more obvious difference in an energy ratio between the main lobe and the side lobes, which means that when the window function is the Kaiser window 3.0, the reflected energy at non-main measurement angles may be greatly reduced, so that the energy emitted and received by the transducer is more concentrated on the main lobe.

FIG. 7B shows the received ultrasonic signal under different window functions when the transducer is used as a receiver. As shown in FIG. 7B, when the window function is a Kaiser window 3.0, the interference of the side lobes reflected at non-main angles is greatly reduced. Therefore, compared to when the window function is a rectangular window, the received signal end has a smaller bounce, thereby reducing distortion at the measurement point.

FIG. 7C shows an amplitude envelope diagram of the emitted ultrasonic signal under different window functions when the transducer is used as a receiver. As shown in FIG. 7C, when the window function is a Kaiser window 3.0, it can be observed that a bounce size and duration of the envelope at the end of the sequence are significantly reduced and shortened, which means that when the window function is the Kaiser window 3.0, other unnecessary reflections may be effectively suppressed.

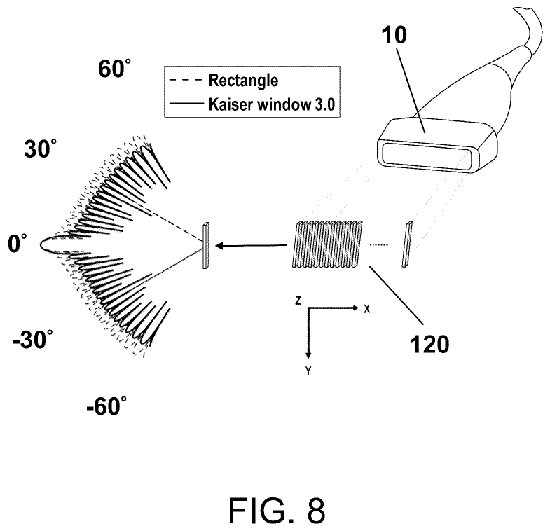

FIG. 8 is a radiation pattern of ultrasonic emitted by a transducer according to an embodiment of the disclosure. As shown in FIG. 8, in polar coordinates, it can be seen that the energy ratio between the main lobe and both sides of the ultrasonic at 0 degrees is more obviously enlarged. The power ratio between the power of the main lobe power and the power of the side lobes has expanded from 13 dB to more than 30 dB. It can be seen that when the window function is directly designed on the probe, the Kaiser window 3.0 may effectively suppress the generation of the side lobes of the ultrasonic.

In summary, the disclosure changes the ultrasonic waveform output by the transducer array by cutting the transducer array, and suppresses the power of the side lobes of the output ultrasonic, so as to improve the focusing function of the ultrasonic generated by the transducer array, thereby improving the resolution of the detected ultrasonic image.

What is claimed is:

1. An ultrasonic transducer array configured to generate ultrasonic, the ultrasonic transducer array comprising:
a plurality of transducers, wherein the plurality of transducers are arranged along a first direction, each of the plurality of transducers has a plurality of grooves arranged along a second direction perpendicular to the first direction, and the plurality of grooves extend along the first direction,
wherein a density of the plurality of grooves along the second direction decreases from both ends of the transducer toward a center of the transducer.

2. The ultrasonic transducer array according to claim 1, wherein the density of the plurality of grooves along the second direction corresponds to an energy distribution function, and the energy distribution function makes a power difference between a power of a main lobe and a power of side lobes of the ultrasonic greater than 20 dB.

3. The ultrasonic transducer array according to claim 2, wherein the energy distribution function is a Kaiser Window.

4. The ultrasonic transducer array according to claim 1, wherein the transducer along the second direction is divided into a plurality of equal portions, and a number of grooves in each of the plurality of equal portions corresponds to a distribution of an energy distribution function, and the energy distribution function makes a power difference between a power of a main lobe and a power of side lobes of the ultrasonic greater than 20 dB.

5. The ultrasonic transducer array according to claim 1, wherein the transducer along the second direction is divided into a plurality of equal portions, a number of grooves in each of the plurality of equal portions corresponds to a distribution of an energy distribution function, a number of the plurality of equal portions is N, and a number nᵢ of grooves in an i-th equal portion is in the following relation and is rounded down to an integer of integer digits:
$$( 1 - \frac{{E}_{i}}{{E}_{max}} ) \frac{L}{N} \frac{1}{d} ,$$
wherein Eᵢ is an energy of the energy distribution function at the i-th equal portion, Eₘₐₓ is a maximum energy of the energy distribution function, L is a width of the transducer along the second direction, and d is a width of the groove.

6. The ultrasonic transducer array according to claim 1, the transducer along the second direction is divided into a plurality of equal portions, and a central equal portion of the plurality of equal portions does not have a groove.

7. The ultrasonic transducer array according to claim 1, wherein depths of the plurality of grooves decrease from both ends of the transducer toward the center of the transducer.

8. The ultrasonic transducer array according to claim 1, wherein a depth of the groove is greater than or equal to half of a height of the transducer.

9. The ultrasonic transducer array according to claim 1, wherein a width of the transducer along the second direction is half of a wavelength of the ultrasonic.

10. The ultrasonic transducer according to claim 1, wherein each of the plurality of transducers is a rectangle, a short side of the rectangle extends along the first direction, and a long side of the rectangle extends along the second direction.

11. The ultrasonic transducer array according to claim 1, wherein at least one of a number and depths of the plurality of grooves is symmetrically distributed relative to the center of the transducer.

12. An ultrasonic probe, comprising:
a handheld housing, having a first end and a second end;
an acoustic lens, disposed at the first end or the second end of the handheld housing; and
an ultrasonic transducer array, disposed in the handheld housing and close to one side of the acoustic lens, and comprising:
a plurality of transducers, wherein the plurality of transducers are arranged along a first direction, each of the plurality of transducers has a plurality of grooves arranged along a second direction perpendicular to the first direction, and the plurality of grooves extend along the first direction,
wherein a density of the plurality of grooves along the second direction decreases from both ends of the transducer toward a center of the transducer.

13. The ultrasonic probe according to claim 12, wherein the density of the plurality of grooves along the second direction corresponds to an energy distribution function, and the energy distribution function makes a power difference between a power of a main lobe power and a power of side lobes of ultrasonic greater than 20 dB.

14. The ultrasonic probe according to claim 13, wherein the energy distribution function is a Kaiser Window.

15. The ultrasonic probe according to claim 12, wherein the transducer along the second direction is divided into a plurality of equal portions, and a number of grooves in each of the plurality of equal portions corresponds to a distribution of an energy distribution function, and the energy distribution function makes a power difference between a power of a main lobe power and a power of side lobes of ultrasonic greater than 20 dB.

16. The ultrasonic probe according to claim 12, wherein the transducer along the second direction is divided into a plurality of equal portions, a number of grooves in each of the plurality of equal portions corresponds to a distribution of an energy distribution function, a number of the plurality of equal portions is N, and a number nᵢ of grooves of an i-th equal portion is the following relation and is rounded down to an integer of integer digits:
$$( 1 - \frac{{E}_{i}}{{E}_{max}} ) \frac{L}{N} \frac{1}{d} ,$$
wherein Eᵢ is an energy of the energy distribution function at the i-th equal portion, Eₘₐₓ is a maximum energy of the energy distribution function, L is a width of the transducer along the second direction, and d is a width of the groove.

17. The ultrasonic probe according to claim 12, the transducer along the second direction is divided into a plurality of equal portions, and a central equal portion of the plurality of equal portions does not have a groove.

18. The ultrasonic probe according to claim 12, wherein depths of the plurality of grooves decrease from both ends of the transducer toward the center of the transducer.

19. The ultrasonic probe according to claim 12, wherein a depth of the groove is greater than or equal to half of a height of the transducer.

20. The ultrasonic probe according to claim 12, wherein at least one of a number and depths of the plurality of grooves is symmetrically distributed relative to the center of the transducer.
